(19) United States
(12) Patent Application Publication
(10) Pub. No.: US 2010/0247480 A1
(43) Pub. Date: Sep. 30, 2010

(54) DRY POWDER FORMULATIONS FOR LOW-TOXICITY INSECT BAIT

(75) Inventors: Kenneth J. Kupfer, Nokomis, FL (US); Robert E. McManus, Nokomis, FL (US)

Correspondence Address: GIFFORD, KRASS, SPRINKLE,ANDERSON & CITKOWSKI, P.C, PO BOX 7021, TROY, MI, 48007-7021, US

(73) Assignee: KM INVESTORS, LLC, Nokomis, FL (US)

(21) Appl. No.: 12/517,738

(22) PCT Filed: Dec. 3, 2007
(86) PCT No.: PCT/US07/86253

§ 371 Date: Jun. 4, 2009

Related U.S. Application Data
(60) Provisional application No. 60/872,632, filed on Dec. 4, 2006.

(51) Int. Cl. A01N 63/00; A01P 7/04; A01P 19/00

(52) U.S. Cl. 424/84

(57) ABSTRACT

Disclosed are low-toxicity, bio-rational insect baits in dry powdery formulation and related methodology wherein the insect bait compounds are designed, manufactured, packaged, shipped and otherwise handled in a dry powdery bait composition form prior to being mixed and dissolved in water or other solvent, without precipitate, by agricultural growers or other end users to produce a low-toxicity, liquid insect bait effective for utilization in the long-term delivery Liquid Gravity Feed Elimination System, LGFAES, or a equivalent delivery device, for the elimination of a broad range of crop-damaging or otherwise problem crawling, walking and flying insects using lateral transfer of the insect killing substance within the bait to reach insects that have not been attracted to the delivery device creating exponential destruction to the targeted insect infestation.

### CROSS-REFERENCE TO RELATED APPLICATIONS

This application claims priority of U.S. Provisional Patent Application Ser. No. 60/872,632 filed Dec. 04, 2006. The application is also a continuation in part application Ser. No. 11/537,772 filed Oct. 2, 2006.

### FIELD OF THE INVENTION

This invention relates to the field of pest control, and more particularly to insect bait compounds that can be designed, manufactured, packaged, shipped and otherwise handled in a dry powdery form prior to being dissolved with water or other solvent by agricultural growers or other end users for utilization by them in low-toxicity, liquid bait station dispensers for the elimination of a broad range of crop-damaging, or otherwise problem, crawling, walking and flying insects.

### BACKGROUND OF THE INVENTION

Applicants of the instant application have previously described a Dry Powder Formulation for Low-Toxicity Insect Bait in U.S. patent application Ser. No. 11/537,772 filed on Oct. 2, 2006 used in cooperation with the Liquid Gravity Feed Elimination System (LGFAES) detailed in U.S. Pat. No. 6,467,216 B2, issued Oct. 22, 2002.

The LGFAES Station Dispenser, with its weather-sheltering, long-term delivery attributes, permits the use of slow-acting, low-toxicity liquid baits whereby the foraging insects after consuming, or otherwise being contaminated with the bait, leave to die and, in many instances, share this bait or its effect with other insects thus contributing to the elimination of the total problem infestation. In addition, since the liquid bait is stored and provided to the targeted feeding insects entirely within the dispenser, this elimination is accomplished in a totally bio-rational manner. The traditional delivery methods using quick-acting, higher-toxicity baits kill the foraging insects prior to their contact with other targeted insects and fail to adversely affect the balance of their population. With some insect species and in particular ants, the quick killing action causes stress in the other members of their colony and causes them to repopulate in greater numbers. In addition, this broadcast delivery of bait kills beneficial insects and contributes to contamination of the environment. The design of low-toxicity, bio-rational liquid bait focused to attract and kill specific noxious insects, and delivered from weather-sheltered, self-contained dispensers permits its use by organic growers, and permits the concurrent use of beneficial insects by all growers in the control of a broad spectrum of insect species.

An embodiment of the low-toxicity, bio-rational bait compound being discovered and claimed is comprised of pyrethrins, fiprinil, imidaclorprid, spinosad, borates, sterilizing agents, growth regulators, pheromones, virus, BT proteins, bacteria, fungus, parasites or other active ingredients, that when in the diluted liquid bait form, is at a ratio of 2% or less toxicant by percentage weight to the finished bait total volume. An attractant of floral odor, light, pheromone, plant extract, a sugar, honey, molasses, a protein, or combinations of amino acids in varying amounts, or other attractants adaptable to the specific, targeted insect species. A food substance comprised of a plant extract, a sugar, honey, molasses, a protein, or combinations of amino acids in varying amounts; A citric acid, borate or other preservatives will be present in varying amounts to inhibit bait degradation and bacteria growth. A combination of one or more adjuvants such as an antioxidant to increase stability and prolong life of bait; a synergist such as piperonyl butoxide to delay remedial enzyme action in insects; and a pheromone to enhance the effectiveness of the active ingredient and or the attractant, thereby reducing total ingredients by weight required, thus assisting in placing said bait ingredients into solution without precipitate. The bait concentrate is placed in solution when diluted with water, vegetable oil, alcohol, petroleum distillate or other solvent.

### DESCRIPTION OF THE PRIOR ART

The USA Environmental Protection Agency outlines the different types of pesticides into two broad categories, Chemical Pesticides and Biopesticides and further into sub-categories as follows:

### Chemical Pesticides

Organophosphate Pesticides—These pesticides affect the nervous system by disrupting the enzyme that regulates acetylcholine, a neurotransmitter. Most organophosphates are insecticides. They were developed during the early 19th century, but their effects on insects, which are similar to their effects on humans, were discovered in 1932. Some are very poisonous (they were used in World War II as nerve agents). However, they usually are not persistent in the environment.

Carbamate Pesticides affect the nervous system by disupting an enzyme that regulates acetylcholine, a neurotransmitter. The enzyme effects are usually reversible. There are several subgroups within the carbamates.

Organochlorine Insecticides were commonly used in the past, but many have been removed from the market due to their health and environmental effects and their persistence (e.g. DDT and chlordane).

Pyrethroid Pesticides were developed as a synthetic version of the naturally occurring pesticide pyrethrin, which is found in chrysanthemums. They have been modified to increase their stability in the environment. Some synthetic pyrethroids are toxic to the nervous system.

### Biopesticides

Biopesticides are certain types of pesticides derived from such natural materials as animals, plants, bacteria, and certain minerals. For example, canola oil and baking soda have pesticidal applications and are considered biopesticides. At the end of 2001, there were approximately 195 registered biopesticide active ingredients and 780 products. Biopesticides fall into three major classes:

(1) Microbial pesticides consist of a microorganism (e.g., a bacterium, fungus, virus or protozoan) as the active ingredient. Microbial pesticides can control many different kinds of pests, although each separate active ingredient is relatively specific for its target pest[s]. For example, there are fungi that control certain weeds, and other fungi that kill specific insects.

The most widely used microbial pesticides are subspecies and strains of Bacillus thuringiensis, or Bt. Each strain of this bacterium produces a different mix of proteins, and specifically kills one or a few related species of insect larvae. While some Bt's control moth larvae found on plants, other Bt's are specific for larvae of flies and mosquitoes. The target insect species are determined by whether the particular Bt produces a protein that can bind to a larval gut receptor, thereby causing the insect larvae to starve.

(2) Plant-Incorporated_Protectants (PIPs) are pesticidal substances that plants produce from genetic material that has been added to the plant. For example, scientists can take the gene for the Bt pesticidal protein, and introduce the gene into the plant's own genetic material. Then the plant, instead of the Bt bacterium, manufactures the substance that destroys the pest. The protein and its genetic material, but not the plant itself, are regulated by EPA.

(3) Biochemical pesticides are naturally occurring substances that control pests by non-toxic mechanisms. Conventional pesticides, by contrast, are generally synthetic materials that directly kill or inactivate the pest. Biochemical pesticides include substances, such as insect sex pheromones, that interfere with mating, as well as various scented plant extracts that attract insect pests to traps. Because it is sometimes difficult to determine whether a substance meets the criteria for classification as a biochemical pesticide, EPA has established a special committee to make such decisions.

U.S. Pat. No. 5,384,120 discloses that propyl cyclo hexyl acetate is an aggregation pheromone for the German cockroach and the combination of isobornyl acetate and santalol alone or in conjunction with the aggregation pheromone is used for attracting the cockroaches as well as palmettos. More particularly pyrethrum, pyrethrin I, pyrethrin II are included in the formulations. The pyrethrins are disclosed to be in a final weight percentage from 0.01% to 5%.

U.S. Pat. No. 5,480,638 discloses a powdered insecticide bait composition that includes powdered dry pet food, powdered pyrethrin or pyrethroid and boric acid ingredients and a powdered clay drying agent. Also disclosed is a method for preparing the composition, including the steps of grinding the dry pet food into a powder, adding the powdered pyrethrin and boric acid killing ingredients to the pet food granules and thoroughly mixing the ingredients. The resulting powdered mixture is sprinkled around the baseboards of a structure to kill roaches or other scavenging insects and on ant mounds to kill ants.

U.S. Pat. No. 5,683,689 discloses biopesticides and their use to control cockroaches, carpenter ants, and pharaoh ants. Highly virulent isolates of Beauveria bassiana in an agricultural composition are used to specifically control these pests. Exemplified are Beauveria bassiana No. 447, (ATCC 20872), and Beauveria bassiana SP111, (ATCC 74038). Also described are formulations for delivering biocontrol agents to target pests.

U.S. Pat. No. 6,593,299 provides polypeptide pesticidal compounds that inhibit digestion in pests by inhibiting synthesis of pest digestive enzymes, such as TTLE. The compounds are used to control populations of pests, such as populations of blood-ingesting insects. The compounds include a borate compound that results in elevated concentrations of cyclic AMP, such as a phosphodiesterase enzyme inhibitor, or a formamidine. The compounds are disclosed to optionally include pyrethroids such as pyrethrin I and II, fungal spores of Beauveria Bassiana.

U.S. Pat. No. 6,916,469 discloses a gellable ant bait matrix comprising protein, carbohydrate, fat, and sterol as ant-preferred nutrients and uric acid as a bait-enhancing agent. The gellable matrix offers the benefit of its ability to apply the bait in cracks and areas not normally accessible to ant baiting systems. Methods of making ant-preferred matrices of this reference are also provided comprising mixing the various components to form a food.

U.S. Pat. No. 5,928,634 discloses a liquid bait for target insects and methods of attracting or controlling insects by means of its use. This reference specifically discloses the addition of sorbitol as a humectant to retard the drying of the liquid bait. The liquid bait further includes at least one insect attractant that is selected from the group consisting of sucrose, fructose, d-maltose, the lithium salt of saccharin, lithium chloride, and vitamins.

U.S. Pat. No. 5,939,061 discloses an attractant composition for the control of multiple species of pest arthropods, particularly multiple species of pest ants. The composition, which includes a sugar and a salt for base, and water, attracts both oil-loving and sweet-loving ants and is especially useful with water soluble or suspendable toxicants.

U.S. Pat. No. 5,871,780 discloses a pest-controlling composition comprising a borate compound and a compound resulting in elevated concentrations of cyclic AMP, such as a phosphodiesterase enzyme inhibitor, or a formamidine. The borate compound of the pest-controlling composition has increased toxicity as compared to a borate compound acting alone.

### SUMMARY OF THE INVENTION

According to the present invention, there is provided an insect-controlling composition comprising a low-toxicity, species specific bio-rational, insect-killing or neutralizing active ingredient, an attractant, a food substance, a buffer, a preservative, and one or more adjuvants to be used with a liquid bait dispensing station to control insects using lateral transfer of the composition to other of the specific insects away from the station.

It is an object of the present invention to provide a low-toxicity liquid bait focused to attract and kill or otherwise neutralize specific crop-damaging or otherwise problem insects for use by organic growers and other environment-sensitive end-users in both urban and agricultural settings.

It is another object is to reduce or negate the need for the indiscriminate broadcast delivery of insecticides by designing a number of formulas for the elimination of a broad range of problem crawling, walking and flying insects in an environment-friendly manner.

It is another object of the present invention to provide bait to the targeted insects on a continuous, uninterrupted basis, whereas with the broadcast delivery method, the active ingredient may be restricted to broadcast delivery once or twice a year, because of Government regulations or concern that the insects develop a resistance to the pesticide; and after application, this bait unfavorably affects beneficial insects, is subject to rapid dissipation of effectiveness because of the sun and rain, and causes pesticide run-off into the environment.

It is another object of the present invention to permit and promote the concurrent use of beneficial insects in the control of a broad spectrum of insect species.

It is another object of the present invention to provide a delayed kill or neutralizing of the insect in order to create the opportunity to unfavorably affect the balance of the targeted insect infestation, as apposed to the rapid kill of the foraging insects, only.

It is another object of the present invention is to provide a low-toxicity, insect-controlling composition designed, manufactured, packaged, shipped and otherwise handled in a dry powdery form prior to being completely dissolved with water or other solvent by agricultural growers or other end users as means to greatly reduce the bait's volume and weight and related cost to produce and handle prior to its final use.

It is another objective of the present invention to provide the insect-controlling composition in a solution without precipitate that is compatible to be used in concert with the gravity-feed, long-term delivery, Liquid Gravity Feed Elimination System (LGFAES), or a comparable weather-sheltered, air-restricted, liquid insect bait delivery device that maintains the integrity of the bait over a period of several months.

These and other objects become apparent from the following description of preferred embodiments taken together with the appended claims.

### DETAILED DESCRIPTION OF THE PREFERRED EMBODIMENTS

As used herein, the terms “bait” and “attractant” mean any substances that entice an insect to ingest, or come in contact with, that substance alone, or combined with one or more other substances, including an insect toxicant or other active ingredient.

As used herein, the term “growth regulator” means any of the endogenous or exogenous substances that inhibit the normal growth of animals, insects, plants, fungi, or their tissues, or the growth of microorganisms.

The present invention is described as a formulation for use by the growers or other end user of a low-toxicity, bio-rational, insecticidal bait for controlling many crawling, walking and flying arthropod pests.

The bait disclosed in the present invention is intended for use in system wherein insects are attracted to a bait dispensing system and the foraging insects after consuming, or otherwise being contaminated with the bait, leave to die or become neutralized and, in many instances, share this bait or its effect with other targeted insects thus contributing to the destruction of the total problem infestation. Such a system of insect control is referred to as a “horizontal or lateral transfer” method.

In one embodiment, the bait composition in the present invention comprises a pyrethroid component which is at a ratio of 1% or less by percentage weight to finished bait total volume. The pyrethroid component is selected from the group of active ingredients including pyrethroid, fiprinil, imidaclorid, spinosads, borates, sterilizing agents, growth regulators, pheromones, virus, BT proteins, bacteria, fungus, parasites or any combination thereof.

The bait composition further comprises a combination of attractants, food substance, buffer, preservatives, and adjuvants. The attractants include floral odor, light, pheromone, a plant extract, a sugar, honey, molasses, a protein, or combinations of amino acids in varying amounts; or other attractants adaptable to multiple insect species to attract insects to consume or otherwise be exposed to the active ingredients. The food substance include a plant extract, a sugar, honey, molasses, a protein, or combinations of amino acids in varying amounts; or other fluid or material adaptable to be ingested by multiple insect species The buffer is comprised of an compatible acid or alkaloid or a combination thereof to adjust bait to desired ph. The preservatives include, but are not limited to, sodium benzoate, borates and citric acid. The preservatives are present in various amounts to inhibit bait degradation and bacteria growth. The adjuvant assists in increasing the effectiveness of the active ingredient and the attractant, and aids in placing all of the above ingredients in solution with little or no precipitation so as to improve solubility of the bait composition.

The attractants include floral odor, light, pheromone, a plant extract, a sugar, honey, molasses, a protein, or combinations of amino acids in varying amounts; or other attractants adaptable to attract targeted species specific insects to consume or otherwise be exposed to the active ingredients.

Another embodiment of the liquid bait dispenser lateral transfer methodology of the present invention makes available the potential bio-rational use of ants as host carriers of fungus, virus or other pathogens to fatally infect targeted mealy bugs and other homoptera. Argentine ants and similar ants farm and protect the homoptera in order to harvest their honeydew, and therefore provide the vehicle for the transfer of a homoptera-specific pathogen that the ants become contaminated with when feeding.

In another embodiment, species specific fungal and or viral pathogens are the active ingredient used in the LGFAES dispenser, or its equivalent, to control a broad range of insects such as the Gypsy Moth or the Southern Pine Beetle that create extensive damage to hardwood and conifer trees.

The bait composition within the present invention is exclusive of any liquid component such as water. More specifically, the bait composition is presented with a dry powder formulation. The bait composition within the present invention is neither a gel matrix nor a liquid.

The bait composition is formulated as a bait concentrate. When mixed with and dissolved in water, vegetable oil, alcohol, petroleum distillate or other solvents, the bait concentrate changes into a liquid bait, without precipitate, suitable for use in the gravity-feed, long-term delivery, LGFAES dispenser system or equivalent.

The bait with its composition claimed herein in the present invention takes the form of powdery material, with the amount of ingredients included expressed by percentage weight to finished bait total volume.

Several advantages are obtained by using a low-toxicity pyrethroid or fungus based bait and feeding the insects within a self-contained dispenser. Among these advantages are: avoids the broadcast delivery of pesticides that indiscriminately kills beneficial insects and pollutes the environment; provides for continuous season-long insect control rather than to the 1-2 times broadcast delivery allowed; permits utilizing an attractant and active ingredient designed to selectively kill, contaminate or otherwise neutralize, the targeted insects; allow beneficial insects to be used concurrently in the control of a broad spectrum insect species; permits the bait's use by organic growers; and encourages its use by environment sensitive growers.

The bait composition within the present invention is applicable to be used with the LGFAES Station Dispenser (U.S. Pat. No. 6,467,216). The LGFAES dispenser provides a low-maintenance, weather-resistant ant elimination system via a practical, safe mechanical liquid delivery platform designed for use with a low-toxicity liquid insect bait. The LGFAES dispenses a controlled amount of low toxic liquid bait from an air-restricted reservoir over an extensive period of time so as to reduce liquid bait degradation due bacteria growth, dead insect and plant contamination and loss due to evaporation. With the combined application of the LGFAES Station Dispenser and the bait within the present invention, the foraging insects after consuming, or otherwise being contaminated with the bait, leave to die or become neutralized and, in many instances, share this bait or its effect with other targeted insects thus contributing to the destruction of the total problem infestation In addition, since the liquid bait stored and provided to the foraging ants is entirely within the dispenser, the elimination of the infestation is accomplished in a most bio-rational manner.

### EXAMPLE 1

A dry powdery bait composition comprises the following ingredients by percentage weight to finished bait total volume:
0.1% to 1.0% pyrethroid as an active ingredient;
15% fructose as an attractant;
0.5% to 2.0% plant extract as a food substance;
2% to 4% citric acid as a buffer to lower the ph;
0.1% to 0.25% sodium benzoate as a preservative; and

An as needed amount of floral odor, species specific pheromones to augment the attractant; anti oxidant to increase stability and prolong life of the bait; and piperonye butoxide as a synergist, to help prevent insect from breaking down pesticide before it kills them are added as adjuvants.

### EXAMPLE 2

A dry powdery bait composition comprises the following ingredients by percentage weight to finished bait total volume:
0.3% to 2.0% Beauveria Bassiana (fungus)
15.0% to 25.0% fructose as an attractant;
0.5% to 2.0% plant extract as a food substance;
2% to 4% citric acid as a buffer to lower the ph;
0.1% to 0.5% disodium octoborate as a preservative; and

As needed amounts of floral odor and species specific pheromones to supplement the attractant are added as adjuvants.

Examples of use of the baits of the present invention to control specific insects utilizing lateral transfer technology include using a sugar/protein based solution to attract Argentine ants to a bait dispenser to feed on a low-toxity, 1% boric acid, liquid bait. The ants then leave the dispenser and return to their nest to feed the queen and the other workers and cause the death of the total colony. Removing the Argentine ants, that are protecting the mealy bugs, aphid, scale and other homoptera in order to harvest their honeydew, allows the beneficial insects to control the homoptera, providing a highly effective, bio-friendly, method of eliminating the broadcast spraying of Lorsban and other toxic organophosphates.

Banana weevils can be attracted to dispenser stations with the aggregation pheromone, isomer sordidin to contaminate with Beauveria bassiana fungus and upon leaving interact with and contaminate other weevil to cause exponential damage to an entire weevil infestation.

Mosquitoes can be attracted to dispenser station with carbon dioxide, light, sex pheromones in order to contaminate with one of several fungi, and on leaving to interact with and contaminate the targeted insects again go a long way toward controlling the mosquito population.

It should be apparent that the present invention provides formulations and a method of designing, producing and delivering powdered bait to an end user; that can be dissolved, without precipitate, by the end user to produce a low-toxicity, bio-rational, insect bait that can be used in the LGFAES liquid bait station dispenser, or its equivalent. Most liquid insect baits now sold are highly toxic mixtures, primarily colloidal suspensions that are designed for the quick kill of the foraging insects, prior to dissipation of the bait by the sun, rain and runoff thus polluting the environment, and are not affecting desired exponential damage to the entire targeted insect infestation. The bait as presently disclosed is without precipitate so as not to interrupt the LGFARES dispensing action. And it also includes preservative that inhibits bait degradation and bacteria growth.

While the foregoing description provides specific embodiments of the present invention, it should be appreciated that these embodiments are described for the purposes of illustration only, and that numerous alterations and modifications may be practiced by those skilled in the art without departing from the spirit and scope of the invention. It is intended that all such modifications and alterations be included insofar as they come within the scope of the invention as claimed or the equivalent thereof.

1. An insect bait in the form of dry powder, comprising:
an insect-killing agent,
an attractant,
a food substance,
a buffer,
a preservative, and
an adjuvant.

2. The bait of claim 1 wherein said insect-killing agent is selected from the pesticide group consisting of pyrethroid, fiprinil, imidacloprid, and any combination thereof.

3. The insect bait of claim 1, wherein said insect-killing agent is selected from the biopesticide group consisting of spinosad, borate, sterilizing agent, growth regulator, pheromone, BT protein, bacteria, virus, fungus, parasite or any combination thereof.

4. The insect bait of claim 2, wherein said insect-killing agent is a pyrethroid, in a concentration range of 0.1% to 1.0% by percentage weight to finished bait total volume.

5. The insect bait of claim 1, wherein said insect-killing agent is beauveria bassiana, a fungus, in a concentration range of 0.3% to 2.0% by percentage weight to finished bait total volume.

6. The insect bait of claim 1, wherein said attractant comprises a floral odor, light, pheromone, plant extract, honey, molasses, glucose, fructose, maltose, sucrose, protein, amino acid, or any combination thereof.

7. The insect bait of claim 1, wherein said attractant consists of 15.0% to 25% fructose by percentage weight to finished bait total volume.

8. The insect bait of claim 1, wherein said food substance comprises a plant extract, honey, molasses, glucose, fructose, maltose, sucrose, protein, amino acid, or any combination thereof.

9. The insect bait of claim 1, wherein said food substance comprises a range of 0.5% to 2.0% plant extract by percentage weight to finished bait total volume.

10. The insect bait of claim 1, wherein said buffer comprises an acid or alkaloid to adjust bait to desired ph.

11. The insect bait of claim 1, wherein said buffer comprises a range of 2.0% to 4.0% citric acid by percentage weight to finished bait total volume.

12. The insect bait of claim 1, wherein said preservative comprises a sodium benzoate, a citric acid, disodium octoborate, or any combination thereof.

13. The insect bait of claim 1, wherein said preservative is sodium benzoate in the range of 0.1% to 0.25% by percentage weight to finished bait total volume.

14. The insect bait of claim 1, wherein said preservative is disodium octoborate in the range of 0.1% to 0.5% by percentage weight to finished bait total volume.

15. The insect bait of claim 1, wherein said adjuvant is an antioxidant; a synergist such as piperonyl; attractant and or growth regulator pheromone; or other material to assist in making the bait more effective and in placing said bait ingredients into solution without precipitate.

16. The insect bait of claim 1, wherein said adjuvant is an as needed amounts of floral odor, species specific pheromones attractant; anti oxidant; and piperonye butoxide synergist.
